(19) United States
(12) Patent Application Publication
(10) Pub. No.: US 2005/0275959 A1
(43) Pub. Date: Dec. 15, 2005

(54) Total reflection prism for projector

(75) Inventors: Satoru Kawaai, Saitama-Shi (JP); Hitoshi Shimizu, Saitama-Shi (JP)

Correspondence Address: YOUNG & THOMPSON, 745 SOUTH 23RD STREET, 2ND FLOOR, ARLINGTON, VA, 22202, US

(73) Assignee: FUJINON CORPORATION, SAITAMA-SHI (JP)

(21) Appl. No.: 11/147,266

(22) Filed: Jun. 8, 2005

(30) Foreign Application Priority Data
Jun. 9, 2004 (JP) 2004-171633

(51) Int. Cl. G02B 5/04

(52) U.S. Cl. 359/834; 359/831

(57) ABSTRACT

A total reflection prism includes two prisms having a shape of a triangular prism of a first prism and a second prism. The first prism includes an illuminating light incident face, a total reflection face and a panel reference face. The second prism includes an image light incident face on which image light is incident from the first prism, an image light emitting face from which image light is emitted, and a side end face. An edge line portion of a sharp edge is formed between the image light emitting face and the side end face and therefore, a light amount of OFF light reflected by the edge line portion and projected to a screen becomes extremely smaller than a light amount of ON light and does not effect an influence on quality of a projected image.

This application is based on Japanese Patent application JP 2004-171633, filed Jun. 9, 2004, the entire content of which is hereby incorporated by reference. This claim for priority benefit is being filed concurrently with the filing of this application.

### BACKGROUND OF THE INVENTION

1. Technical Field of the Invention

The present invention relates to a total reflection prism preferable for a projector for projecting an image to a screen by using a digital micromiror device as an image display panel.

2. Description of the Related Art

Attention is attracted to a reflection type projector having a digital micromirror device (DMD) as an image display panel. DMD is provided with a number of micromirrors aligned in a matrix shape and an inclination of each micromirror is switched to ON position and OFF position based on a control signal. Light (ON light) incident on a micromirror at the ON position is reflected to a projecting optical system and light (OFF light) incident on a micromirror at the OFF position is reflected to outside of the projecting optical system. In DMD, ON light reflected by each micromirror reproduces one pixel and brightness of one pixel is determined by a time period in which the micromirror stays at the ON position.

According to a projector of a single plate type for forming an image by using one sheet of DMD, a total reflection prism is used for guiding illuminating light efficiently to DMD and making image light modulated by DMD pertinently incident on a projecting optical system. The total reflection prism is constituted by, for example, two triangular prisms (refer to JP-A-2002-6257). Illuminating light incident on the total reflection prism is totally reflected to DMD at inside thereof to illuminate DMD. By spatial light modulating operation of DMD, illuminating light is modulated to image light comprising an amount of a number of pixels of ON light. Image light is emitted from the total reflection prism to be incident on the projecting optical system and image light focused by the projecting optical system is projected to enlarge on a screen.

According to the total reflection prism of the background art, there is a case in which a portion of OFF light emitted from DMD is inwardly reflected by a side edge portion of the total reflection prism to constitute stray light to produce ghost in a projected image. Therefore, generally, a surface of the total reflection prism is coated with an antireflection film to restrain stray light from being generated. Further, according to the total reflection prism described in JP-A-2002-6257, a side end face constituting a factor of generating stray light is made to be in parallel with a progressing path of OFF light to thereby prevent stray light by OFF light from being generated.

However, a prism part requesting a high face accuracy is subjected to chamfer (flat facing) processing at respective edge line portions with an object of protecting the prism part frombeing chipped off. The total reflection prism is provided with the edge line portion in a region of passing OFF light and therefore, there poses a problem that OFF light is inwardly reflected by the edge line portion to constitute stray light and ghost is brought about in a projected image. Further, although according to the total reflection prism described in JP-A-2002-6257, the edge line portion can be escaped from the region of passing OFF light, since the prism is large-sized, there is brought about a drawback that compactness of an optical system is deteriorated and fabrication cost is increased. The invention has been carried out in consideration of the above-described problem.

### SUMMARY OF THE INVENTION

It is an object thereof to provide a total reflection prism for restraining stray light from being generated by reflecting OFF light by an edge line portion without accompanied by large-sized formation of the prism.

In order to achieve the above-described object, a total reflection prism for a projector of the invention is characterized in comprising a first prism including an illuminating light incident face on which illuminating light is incident, a total reflection face for totally reflecting the incident illuminating light by an inner face thereof, and a panel reference face in parallel with an image display panel for modulating the illuminating light into image light for transmitting the illuminating light totally reflected by the total reflecting face and the image light from the image display panel, and a second prism including an image light incident face which is in parallel with the total reflection face and on which the image light is incident from the first prism, an image light emitting face which is in parallel with the panel reference face and from which the image light is emitted, and a side end face in which an edge line portion for transmitting OFF light reflected by the image display panel is formed by a sharp edge between the side end face and the image light emitting face. Further, the sharp edge is an edge formed by polishing two optical faces contiguous to each other via the edge line portion and represents a state of removing roundness, recesses and projections or the like of the edge line portion by die molding or the like.

Further, the invention is preferably characterized in that an apex angle of the image light emitting face and the side end face of the second prism is substantially a right angle. The invention is still preferably characterized in that the first and the second prisms comprise triangular prisms. The invention is much more preferably characterized in that an air gap is provided between the total reflection face of the first prism and the image light incident face of the second prism.

According to the invention, the edge line portion present in the region for passing OFF light is constituted by the sharp edge and therefore, OFF light constituting stray light by being reflected by the edge line portion is not generated, an influence of ghost projected to the projected image is eliminated, and contrast of the image can be improved. Further, it is not necessary to increase a size of the prism and therefore, compactness of the optical system can be maintained and fabrication cost can be prevented from being increased.

### BRIEF DESCRIPTION OF THE DRAWINGS

FIG. 1 is an outline constitution view showing one embodiment of a projector.

FIG. 2 is a constitution view showing one embodiment of a total reflection prism.

FIGS. 3A and 3B are explanatory views showing a difference of operation between the invention and a comparative example.

Reference numerals are used to identify various elements in the drawings including the following:
10 projector
11 light source apparatus
14, 35 total reflection prisms
15 DMD
16 projecting optical system
25 first prism
25a illuminating light incident face
25b total reflection face
25c panel reference face
26, 37 second prisms
26a image light incident face
26b image light emitting face
26c side end face
30, 36 edge line portions

### DETAILED DESCRIPTION OF THE INVENTION

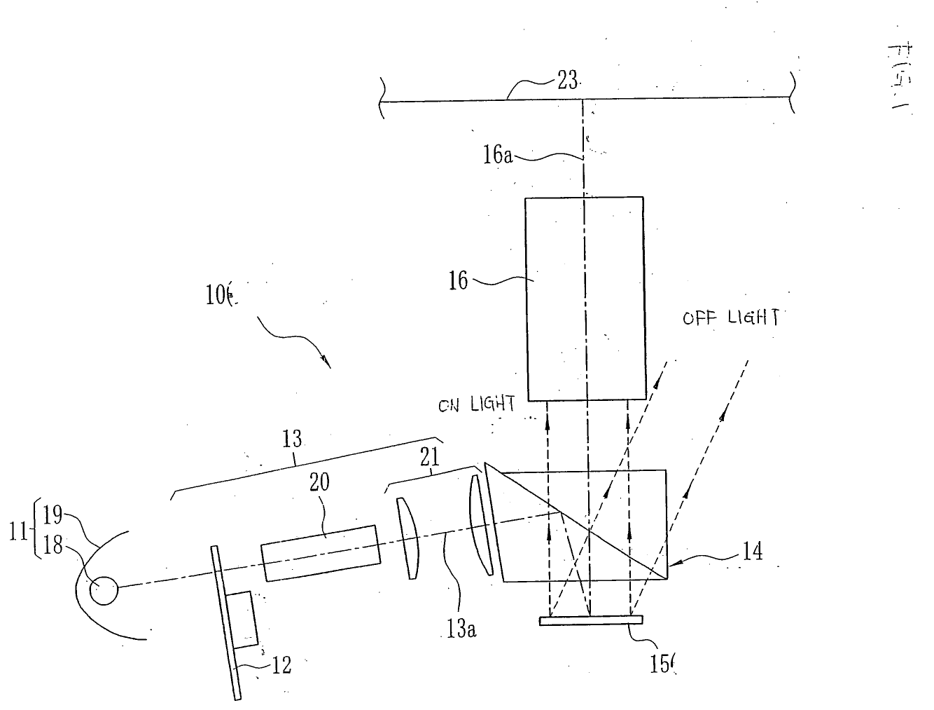

In FIG. 1, a projector 10 is provided with a light source apparatus 11, a color wheel 12, an illuminating optical system 13, a total reflection prism 14, DMD 15, and a projecting optical system 16. The color wheel 12 is arranged with respective color filters for transmitting only red color light, green color light, blue color light on a circular disk constituting a base plate at predetermined intervals in a circumferential direction. By rotating the color wheel 12, white color from the light source 18 is separated into colors by a unit of predetermined time period and is incident on the illuminating optical system 13.

The illuminating optical system 13 comprises a rod integrator 20 and a relay lens 21. The rod integrator 20 comprises, for example, glass formed in a shape of a quadrangular prism and light transmitted through the color wheel 12 is incident thereon. Light incident on the rod integrator 20 is totally reflected by a plurality of times at inside thereof to constitute illuminating light having a uniform brightness and is emitted from the rod integrator 20. Illuminating light emitted from the rod integrator 20 is incident on the total reflection prism 14 via the relay lens 21.

Illuminating light incident on the total reflection prism 14 is incident on DMD 15. As is well known, DMD 15 is provided with a number of micromirrors 15a for reflecting illuminating light to modulate illuminating light to image light having image information by modulating illuminating light for respective pixels. The total reflection prism 14 guides illuminating light to DMD 15 and emits image light from DMD 15 to the projecting optical system 16. The projecting optical system 16 focuses image light on a screen 23 to project to enlarge the image.

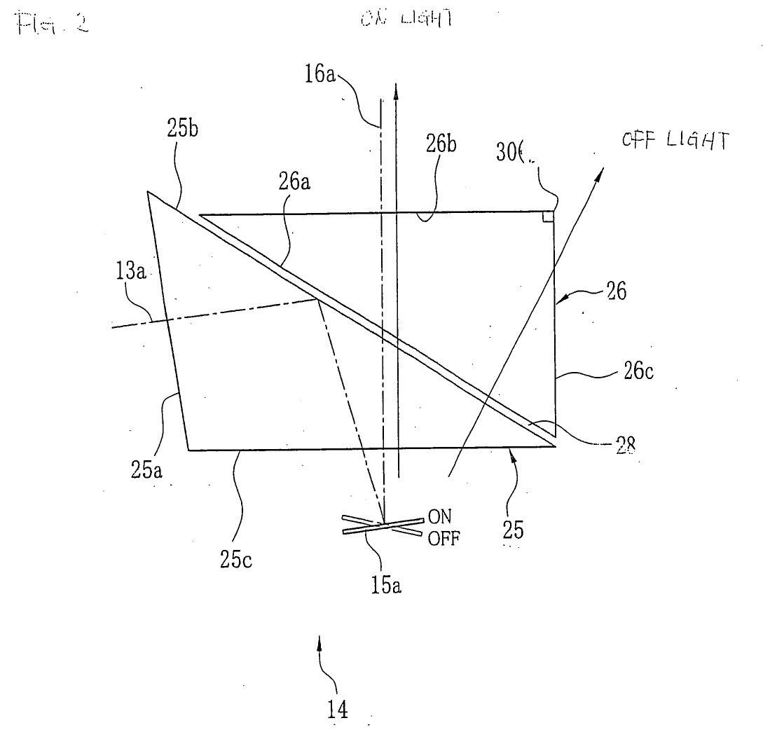

In FIG. 2, the total reflection prism 14 is constituted by two triangular prisms of a first prism 25 and a second prism 26. The first prism 25 includes three planes of an illuminating light incident face 25a on which illuminating light from the relay lens 21 is incident, a total reflection face 25b for totally reflecting illuminating light by making illuminating light from the illuminating light incident face 25a incident thereon by an angle satisfying a critical angle, and a panel reference face 25c in parallel with DMD 15 constituting an image display panel. The illuminating light incident face 25a is orthogonal to an optical axis 13a of the illuminating optical system 13 and illuminating light is incident thereon orthogonally. The total reflecting face 25b is ensured with a predetermined inclination angle such that illuminating light passing the illuminating light incident face 25a is incident thereon by an angle larger than the critical angle. The panel reference face 25c transmits illuminating light totally reflected by the total reflection face 25b and transmits image light from DMD 15.

The second prism 26 includes three faces of an image light incident face 26a on which image light from the first prism 25 is incident, an image light emitting face 26b for emitting incident image light to the projecting optical system, and a side end face 26c disposed outside a light path of image light. The image light incident face 26a is opposed to the total reflection face 25b in parallel therewith. An air gap 28 is provided between the total reflection face 25b and the image light incident face 26a. The air gap 28 is operated to increase an efficiency of totally reflecting illuminating light incident on the first prism 25 by the total reflection face 25b by increasing a difference between refractive indices of inside and outside of the first prism 25. The image light emitting face 26b is in parallel with the panel reference face 25c of the first prism 25 to thereby prevent an aberration by transmitting image light through the total reflection prism 14 from being brought about. Further, the image light emitting face 26b is orthogonal to an optical axis 16a of the projecting optical system 16.

An apex angle of the side end face 26c and the image light emitting face 26b of the second prism 26 is substantially right angle. The apex angle is from 85° to 95°, preferably 87° to 93°, still preferably 89° to 91°. An edge line portion 30 constituting a sharp edge is formed between the image light emitting face 26b and the side end face 26c. The edge line portion 30 is an intersection formed by making one polished face reach other polished face by planarly polishing the image emitting face 26b and the side end face 26c from a rounded state immediately after molding the second prism 26 formed of a glass material. Although the side end face 26c is a face disposed outside of the light path of image light, the side end face 26c is disposed in a light path of OFF light produced in modulating illuminating light into image light. Further, the image light emitting face 26b and the side end face 26c of the second prism 26 are provided with antireflection films at regions thereof for passing OFF light to thereby restrain OFF light from constituting stray light at inside of the second prism 26 by being reflected inwardly at respective faces thereof.

Next, operation of the projector 10 will be explained. Light source light of white color is emitted from the light source apparatus 11. Light source light is separated into colors in a time-sequential style by the color wheel 12 and the respective pieces of color light subjected to color separation are incident on the illuminating optical system 13. The illuminating optical system 13 converts light source light subjected to color separation into illuminating light having a uniform light amount distribution such that a brightness of the image projected to the screen 23 is not deviated. Illuminating light emitted from the illuminating optical system 13 is incident on the total reflection prism 14.

Illuminating light is incident on the illuminating light incident face 25a of the first prism 25, totally reflected by the total reflection face 25b and emitted from the panel reference face 25c to be incident on DMD 1S. ON light and OFF light are emitted from DMD 15. ON light constituting image light is incident on the first prism 25 orthogonally to the panel reference face 25c, transmits through the total reflection face 25b and the air gap 28 and is incident on the second prism 26 from the image light incident face 26a. ON light emits from the image light emitting face 26b of the second prism 26 and is incident on the projecting optical system 16.

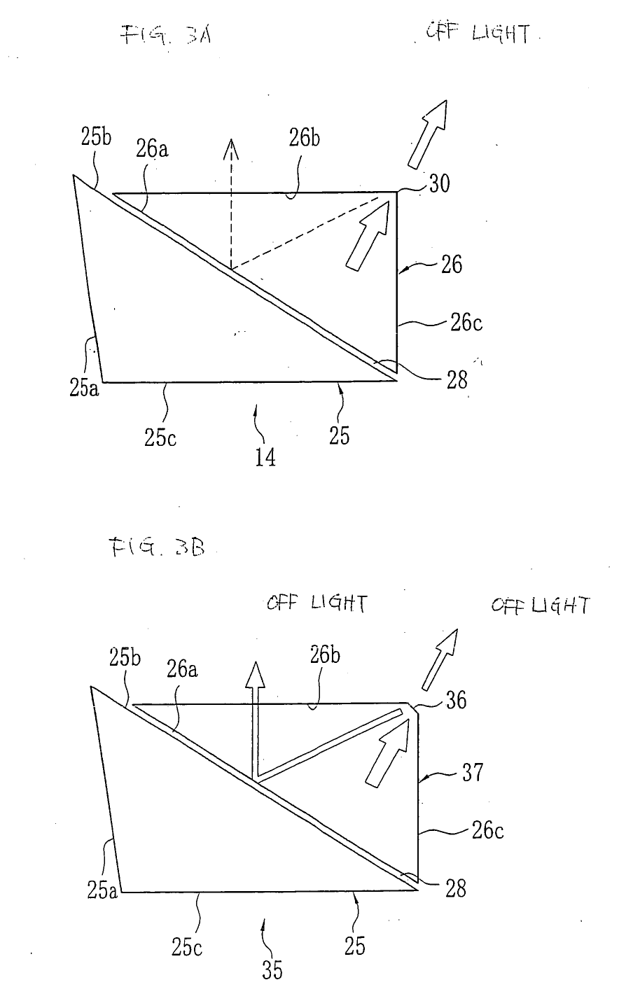

In FIG. 3A, OFF light emitted from DMD 15 progresses in a direction inclined to ON light by a predetermined angle. OFF light is incident on the first prism 25 from the panel reference face 25c, passes the total reflection face 25b and the air gap 28 and is incident on the second prism 26 from the image light incident face 26a. OFF light incident on the second prism 26 passes in a region including the image light emitting face 26b and the side end face 26c and therefore, a portion of OFF light reaches the edge line portion 30. A portion of OFF light reaching the edge line portion 30 transmits through the edge line portion 30 and emitted from the second prism 26 and a remaining portion thereof is reflected by the edge line portion 30 to constitute stray light. An area of the edge line portion 30 constituting the sharp edge is very small and therefore, a light amount of OFF light reflected by the edge line portion 30 is small. Although OFF light reflected by the edge line portion 30 is reflected by the image light incident face 26a of the second prism 26 and is incident on the projecting optical system 16 from the image light emitting face 26b, a light amount thereof is extremely smaller than a light amount of image light and does not effect an influence on quality of the image formed at the screen 23.

On the other hand, a total reflection prism 35 shown in FIG. 3B as a comparative example is provided with a second prism 37 having an edge line portion 36 subjected to a chamfer (flat facing) processing of skewed 45° between the image light emitting face 26b and the side end face 26c. Also in the total reflection prism 35, a portion of OFF light emitted from DMD 15 and incident on the edge line portion 36 is reflected by an inner face of the edge line portion to constitute stray light. OFF light reflected by the edge line portion 36 is reflected by the image light incident face 26a of the second prism 37 and is emitted from the image light emitting face 26b to be incident on the projecting optical system 16. However, different from the total reflection prism 14, the edge line portion 36 is chamfered and therefore, an amount of generating stray light incident on the projecting optical system 16 is increased in accordance with a size of an area of the edge line portion 36. Therefore, according to the total reflection prism 35, by overlapping stray light having a large light amount on image light, the stray light constitutes a factor of reducing contrast of the projected image on the screen 23.

In this way, according to the total reflection prism 14, the edge line portion 30 of the image light emitting face 26b and the side end face 26c is formed by the sharp edge and therefore, the light amount of OFF light reflected by the edge line portion 30 is extremely small and stray light projected to the screen along with ON light can be restrained from being generated. Further, according to the total reflection prism of the invention, an edge line portion disposed outside of the region for passing OFF light from DMD may be subjected to the chamfering processing and it is not necessary to constitute all of edge line portions by sharp edges. Further, the invention is not limited to the constitution of the total reflection prism by combining the two triangular prisms but the invention may be constituted by a prism of a shape of other polygonal prism. Further, the second prism 26 may not be constituted, for example, a single prism but may be constituted by a shape of a polygonal prism combining a plurality of prisms.

1. A total reflection prism for a projector comprising:
a first prism including an illuminating light incident face on which illuminating light is incident, a total reflection face for totally reflecting the incident illuminating light by an inner face thereof, and a panel reference face in parallel with an image display panel comprising a digital micromirror device for modulating the illuminating light into image light for transmitting the illuminating light totally reflected by the total reflecting face and the image light from the image display panel; and
a second prism including an image light incident face which is in parallel with the total reflection face and on which the image light is incident from the first prism, an image light emitting face which is in parallel with the panel reference face and from which the image light is emitted, and a side end face in which an edge line portion for transmitting OFF light reflected by the image display panel is formed by a sharp edge between the side end face and the image light emitting face.

2. The total reflection prism of a projector according to claim 1, wherein an apex angle of the image light emitting face and the side end face of the second prism is substantially a right angle.

3. The total reflection prism of a projector according to claim 1, wherein an apex angle of the image light emitting face and the side end face of the second prism is from 85° to 95°.

4. The total reflection prism of a projector according to claim 1, wherein an apex angle of the image light emitting face and the side end face of the second prism is from 87° to 93°.

5. The total reflection prism of a projector according to claim 1, wherein an apex angle of the image light emitting face and the side end face of the second prism is from 89° to 91°.

6. The total reflection prism for a projector according to claim 1, wherein the first and the second prisms comprise triangular prisms.

7. The total reflection prism for a projector according to claim 1, wherein an air gap is provided between the total reflection face of the first prism and the image light incident face of the second prism.

8. The total reflection prism of a projector according to claim 1, wherein at least one of the image light emitting face the side end face is provided with a antireflection film.
